(19) United States
(12) Patent Application Publication
(10) Pub. No.: US 2025/0055591 A1
(43) Pub. Date: Feb. 13, 2025

(54) CELLULAR COMMUNICATION

(71) Applicant: Nokia Technologies Oy, Espoo (FI)

(72) Inventors: Dimitri GOLD, Espoo (FI); Axel MUELLER, Massy (FR); Aditya Umbu Tana AMAH, COPENHAGEN (DK)

(21) Appl. No.: 18/798,001

(22) Filed: Aug. 8, 2024

(30) Foreign Application Priority Data
Aug. 10, 2023 (FI) 20235892

(51) Int. Cl. H04L 1/00; H04B 17/391

(52) U.S. Cl. CPC H04L 1/0003; H04B 17/3912

(57) ABSTRACT

An apparatus configured to perform a performance test involving demodulation of input signals by a user equipment, the test including a sequence of consecutive time intervals and the test including providing to a first receive chain of the user equipment a first wireless input signal and providing to a second receive chain of the user equipment a second wireless input signal, and update the first and second wireless input signals for each time interval, the updating including updating a power level of the first and second wireless input signals and, responsive to a determination that a modulation and coding scheme, MCS, update condition is fulfilled, the updating also comprises updating the MCS of at least one of the first or the second wireless input signal.

### FIELD

The present disclosure relates to cellular communications equipment.

### BACKGROUND

To enable interoperability between devices manufactured by different parties, cellular communication standards define requirements for device performance, such as, for example, demodulation performance.

In case a user equipment, for example, has lower demodulation performance than defined in standards, this user equipment may require a higher transmit power in the network, causing excess interference to other users, adversely affecting a large number of other users and communication parties. It is thus of technical benefit if user equipments conform to similar demodulation performance criteria.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to perform a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and update the first and second wireless input signals for each time interval, the updating comprising updating a power level of the first and second wireless input signals and, responsive to a determination that a modulation and coding scheme, MCS, update condition is fulfilled, the updating also comprises updating the MCS of at least one of the first or the second wireless input signal.

According to a second aspect of the present disclosure, there is provided a method comprising performing a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and updating the first and second wireless input signals for each time interval, the updating comprising updating a power level of the first and second wireless input signals and, responsive to a determination that a modulation and coding scheme, MCS, update condition is fulfilled, the updating also comprises also updating the MCS of at least one of the first or the second wireless input signal.

According to a third aspect of the present disclosure, there is provided an apparatus comprising means for performing a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and updating the first and second wireless input signals for each time interval, the updating comprising updating a power level of the first and second wireless input signals and, responsive to a determination that a modulation and coding scheme, MCS, update condition is fulfilled, the updating also comprises also updating the MCS of at least one of the first or the second wireless input signal.

According to a fourth aspect of the present disclosure, there is provided a non-transitory computer readable medium having stored thereon a set of computer readable instructions that, when executed by at least one processor, cause an apparatus to at least perform a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and update the first and second wireless input signals for each time interval, the updating comprising updating a power level of the first and second wireless input signals and, responsive to a determination that a modulation and coding scheme, MCS, update condition is fulfilled, the updating also comprises updating the MCS of at least one of the first or the second wireless input signal.

According to a fifth aspect of the present disclosure, there is provided a computer program comprising instructions which, when executed by an apparatus, cause the apparatus to at least perform a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and update the first and second wireless input signals for each time interval, the updating comprising updating a power level of the first and second wireless input signals and, responsive to a determination that a modulation and coding scheme, MCS, update condition is fulfilled, the updating also comprises updating the MCS of at least one of the first or the second wireless input signal.

### BRIEF DESCRIPTION OF THE DRAWINGS

FIG. 1A illustrates an example system;

FIG. 1B illustrates signal fading;

FIG. 2 is a flow graph of a demodulation, RRM and/or RF test;

FIG. 3A illustrates MCS switching in a test run;

FIG. 3B illustrates MCS switching in a test run;

FIG. 4 illustrates an example apparatus capable of supporting at least some embodiments of the present invention, and

FIG. 5 is a flow graph of a method in accordance with at least some embodiments of the present invention.

### EMBODIMENTS

A user equipment demodulation, radio resource management, RRM, or radio frequency, RF, test mechanism is herein disclosed, which enables testing the user equipment's behaviour in fading and fast-moving circumstances. In detail, a modulation and coding scheme, MCS, may be adapted during the test independently in two distinct signals which are provided to two distinct reception chains of the user equipment.

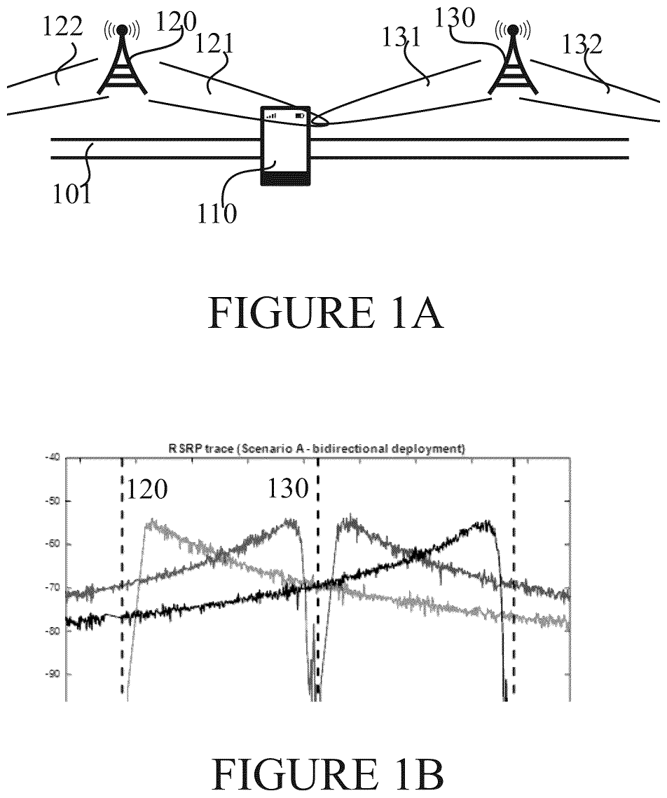

FIG. 1A illustrates an example system. The system comprises a user equipment 110 of a cellular communication system. User equipment 110 may comprise, for example, a smartphone, a feature phone, a tablet computer, a laptop computer, an Internet of Things node, a connected car connectivity module or a mobile hotspot, for example. User equipment, UE, 110 is progressing along track 101, which may comprise a train track or a highway, for example. Along the route of track 101 are disposed a set of base stations, transmission reception points, TRPs of remote radio heads, RRHs, 120, 130. These will be referred to as RRHs in the following, with no limitation in scope. An RRH may be considered a fixed transmitter. RRHs 120, 130 may be distributed along track 101 at regular intervals, at a constant distance from track 101, such as 10 or 150 meters away from track 101, for example. A beam 121 of RRH 120 is directed toward track 101 at an angle, and likewise a beam 131 of RRH 130 is directed toward track 101 at a similar angle. Beam 122 of RRH 120 and beam 132 of RRH 130 are also illustrated in FIG. 1A, in part only due to space constraints of the figure. The aim of beams 121, 122, 131 and 132 is to provide coverage to UEs as they move along track 101.

In some embodiments, each RRH has more than two beams, such as four beams, such that beams additional to those illustrated in FIG. 1A are directed toward track 101 at a different angle than the illustrated beams. The used system may comprise, for example a fifth generation, 5G, system as standardized by the 3^{rd} generation partnership project, 3GPP. The frequency range used may be frequency range 2, FR2, operating at 6 GHz and higher, as opposed to FR1 at under 3 GHz or under 6 GHz.

UE 110 has two antenna panels, each antenna panel having its own baseband receive chain, enabling thus reception of two distinct signals over the respective two distinct antenna panels. The two distinct signals are received via the distinct receive chains. The UE may have more than two antenna panels, such that each of the more than two antenna panels may have its own baseband receive chain. This may be referred to as multi-rx chain operation. As the UE proceeds along track 101, which may be a high-speed train track, it will hand over from beam to beam based on measurements of beam strength. In the illustrated coverage situation with regular features, such as inter-RRH distance and equal distance from track 110, handovers are likely to happen at fairly regular intervals.

Testing demodulation, radio resource management, or RF performance of UEs is performed for cellular systems, since UEs from different manufacturers need to be capable of demodulating signals received in the UE at roughly a same signal-to-noise ratio, as otherwise less sensitive UEs will request transmit power increases from the system, negatively affecting overall power balance since increasing the transmit power increases also interference, and increasing interference depletes communication capability from other UEs which are compliant with a demodulation, RRM and/or RF capability requirement. In a scenario such as that illustrated in FIG. 1A, demodulation, RRM and/or RF performance may be tested separately to testing more static scenarios, since a UE needs to be able to perform well also in this case, which is not rare in today's environment where public transport is very common. Compared to a static test simulating demodulation, RRM and/or RF performance in a non-moving or pedestrian radio channel, the case of FIG. 1A is more challenging owing to faster UE movement and received signal power asymmetry between beams received over distinct antenna panels.

More specifically, in the test of behaviour in a scenario such as that of FIG. 1A, the UE under test may be tested with simultaneous reception over two antenna panels and receive chains, and thus two independent radio links to two RRHs, such as RRHs 120, 130. In the test, the UE may be kept stationary in a test equipment which provides to the UE signals which simulate movement of the UE in e.g. a train along track 101. The test equipment may thus be configured to generate two test signals, to the two antenna panels, the two test signals being processed to undergo simulated fading according to a channel model, which may include random and non-random components. The random components may be statistically independent for the two test signals, to make the test more realistic. The test signals may also be frequency shifted to simulate Doppler shift caused by movement of the UE along the track.

Yet further, the UE may provide feedback on channel quality, based on which the test equipment may adapt the test signals further, such as by changing the modulation and coding scheme, MCS. Thus when the UE provides feedback on channel quality, fulfilment of an MCS update condition may be evaluated based on this feedback. For example, in more adverse channel conditions, such as lower signal-to-noise ratio, the modulation constellation may be adapted to a less ambitious one, such as by switching from quadrature amplitude modulation, QAM, 16 to QAM-4 modulation, and the coding rate may likewise be changed so that the test signal comprises more redundancy bits as a proportion to total bits in the test signal. By a less ambitious modulation scheme it is meant that the number of bits per symbol is decreased. Thus during the test, the UE will have to demodulate, at the same time, one of the test signals using a first MCS and another one of the test signals using a second MCS. Further, as is the case in FIG. 1A, the test signal from RRH 120 may be substantially stronger than that from RRH 130, in other words, there may be a power imbalance between the two test signals provided to the UE. In terms of the simulated scenario, the signals from two RRHs may be from two distinct schedulers, resulting in different transmit powers and MCS values used. In some embodiments, the UE under test is not configured to provide feedback on channel quality during the test, rather, the test equipment is configured to change the MCS based on test parameters without UE feedback based on an MCS update condition, for example when transmit power crosses a threshold, or when a simulated position of the UE in the test passes a threshold distance with a simulated RRH.

Different test scenario examples are provided in the following table:

| Parameters | Description | Scenario A | | Scenario B-1 | | Scenario B-2 | |
|---|---|---|---|---|---|---|---|
| Dₛ | Inter-RRH distance | 700 | m | 700 | m | 700 | m |
| Dₘᵢₙ | Distance between | 10 | m | 150 | m | 150 | m |
| | rail track and RRH | | | | | | |
| v | Train velocity | 350 | km/h | 350 | km/h | 350 | km/h |
| f_{d} | Maximum Doppler | 9722 | Hz | 9722 | Hz | 9722 | Hz |
| | frequency shift | | | | | | |
| f_{c} | Carrier frequency | 30 | GHz | 30 | GHz | 30 | GHz |
| Dᵣₓ_{_{—}}ₚₐₙₑₗ | Distance between | 0 | m | 0 | m | 0 | m |
| | two UE Rx panels | | | | | | |
| Ds_offset | Switching | 10 | m | 100 | m | 350 | m |

transmission point
between adjacent
RRHs

Of these the DS_offset parameter defines a distance from a RRH of a point, along the track, where a switch to one RRH to another one takes place. When the MCS can differ between the input test signals, defining when the UE passes the demodulation, RRM and/or RF test becomes of interest. In case the test does not include feedback of signal strength from the UE to the test equipment, switching between RRHs may be performed at regular intervals, at the DS_offset distance after passing a RRH.

FIG. 1B illustrates signal fading. The curves of FIG. 1B illustrate measured values in a realistic environment resembling that of FIG. 1A. As may be seen, as the UE moves along track 101, reference signal received power, RSRP, of a single beam first increases strongly as the UE enters a coverage area of the beam, and then declines as the UE grows more distant from the RRH transmitting this beam. In FIG. 1B, the first two dotted vertical lines from the left schematically denote the locations of RRHs 120 and 130 of FIG. 1A, respectively. The RSRP curve peaking below reference sign 120 corresponds to beam 121, and that peaking under reference sign 130 corresponds to beam 131.

An example test process is now described, wherein a power profile reference signal-to-noise, SNR, profile is defined for both links to pass the test. That is, the SNR will behave, for example, as illustrated in FIG. 1B during the test. Power profile reference SNR is defined. A level of maximum achieved throughput may be referenced in the test requirements. A power profile of the channel may be defined by the specified environment per link, that is, per RRH. MCS values per link may be specified to change according with time/distance in relation to the power profile: The number of different MCS values may be unconstrained, but in some cases only 2 or at most 3 levels are implemented. The switching point of the MCS in the test may be static and located in the middle or in the middle+an offset between pairs of RRH units facing the same direction.

In some tests, the power profile(s) are constant. When the power profiles are constant, the channel model does not comprise random elements, but the SNR declines predictably as a function of increasing distance from a RRH. In other cases, one power profile is defined relative to the other. For example, in the case of constant power profiles, one profile can be defined with Es or SNR as a multiple of another one, such that the multiplier may be an integer, real or floating-point number.

The test may be conducted as a series of time intervals, such that the length of the time interval sets the time resolution of the test. Signal strength, channel fading and/or MCS may be updated for each time interval, if necessary. In some tests, signal strength and channel fading are updated more often than MCS. For example, for some time intervals the signal strength and channel fading are updated while maintaining MCS unchanged

Instead of a reference SNR value defined in the test, another metric of signal quality may be used, for example, signal power, such as Es for primary cell, PCell. The reference SNR value may be defined at the peak power profile point as a sum of all received useful signal powers, or as a sum of a subset of the received useful signal powers, such as only Es pertaining to one antenna panel.

The UE may be considered to have passed the test, if it accomplishes at least a minimum overall throughput during the duration of the test. The minimum throughput may be defined as a percentage of maximum throughput, for example, or as a defined quantity of data, for example in megabytes or gigabytes. Additionally or alternatively, the test may be considered passed if the UE achieves the minimum overall throughput using, as an average used SNR, or as a reference SNR at some point of the power profile, at most a threshold SNR. The SNR profile may be defined in a test configuration of the test, or, alternatively, the test may include a power control loop between the UE and the test equipment. When power control is used, the average used SNR may be determined during the test, based on observing how the power control modifies transmit power. In particular, one condition for the UE passing the test may be, that the UE cannot pass the test unless at least two achieved throughputs meet at least two threshold throughputs, wherein each threshold throughput is specific to an MCS. In other words, the UE needs to achieve the first threshold throughput when operating on a first MCS and the UE needs to achieve the second threshold throughput when operating on a second MCS.

In the test, the UE may be assumed to be moving from RRH k, towards RRH k+1, and so on, like in a high-speed train FR2 deployment as in FIG. 1A. In this case, the UE will be periodically switched from one RRH to another. In the test, the switching point may be selected to be stable at Ds_offset before or after each RRH location along the track. The receive power at any given point, in space or in time, per RRH changes and is defined by the power level trajectories or relative power level trajectories. Power level trajectories may be defined only by pathloss, or also by other factors such as beamforming gain of the transmit beams at the RRH and/or receive beamforming gain at the UE side.

When UE is getting far away from the RRH k and gets closer to RRH k+1, the received signal power changes considerably. Therefore, it is not realistic to test the reception of the signals on different UE panel, and corresponding Rx chains, with the same SNR levels. The MCS values are chosen dynamically in a manner appropriate to the test signal level. In simpler tests, the UE may be simulated as being static but not placed exactly in the middle between consecutive RRHs. The same propagation characteristics from RRH k and RRH k+1 are not necessary for the test to be successfully carried out. Consequently, different MCS values can be selected per link. In more complex tests, where the UE is simulated as moving, SNR values at the antenna panels facing forward and backward will change dynamically, and the stronger SNR will be at times in the forward-facing antenna panel and at other times in the backward-facing antenna panel. Correspondingly, the MCS will change dynamically to both take advantage of stronger MCS and to maintain communication over a weaker SNR panel.

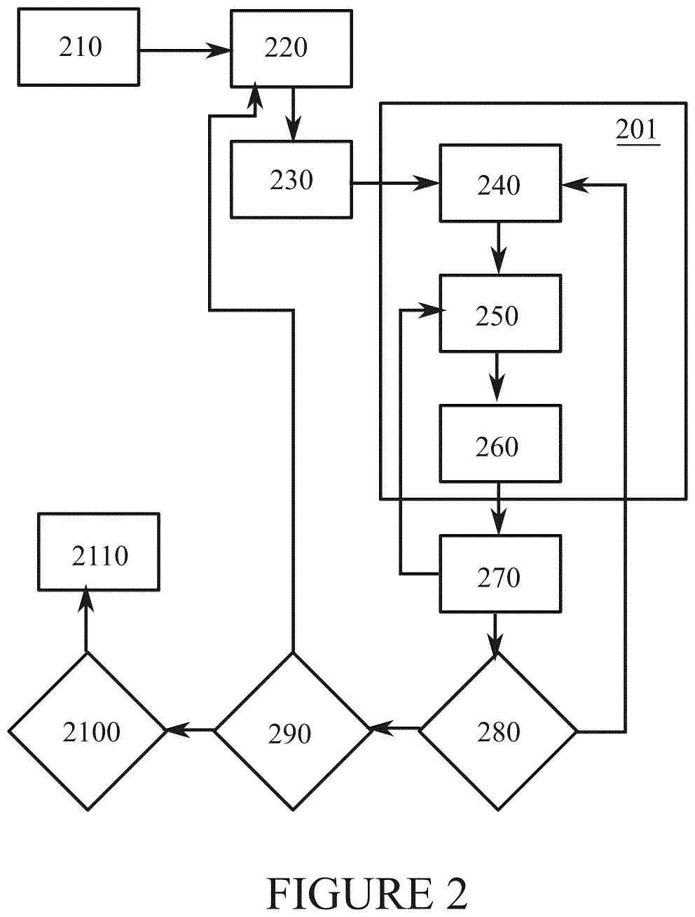

FIG. 2 is a flow graph of a demodulation test. The process begins in phase 210, where initial test parameters are configured. These parameters may comprise, for example, a transmit power range and test duration, as well as a time interval length for the test. The time interval length sets the time resolution of the test. Processing then advances to phase 220, where test run parameters are determined, for example, these parameters may comprise whether switching from RRH to another RRH is based on a constant distance from a previous RRH, or based on measurement reporting from the UE. Also MCS change thresholds may be comprised in these parameters. Processing advances from phase 220 to phase 230.

In phase 230, the device under test, the dual-antenna panel or multi-antenna panel UE, is connected with a test equipment simulating a multiple-RRH base station into a connected state with regard to this base station. During the test, the UE may be switched between RRHs of the same base station, and between RRHs of different base stations. The different base stations may be simulated by the same test equipment. Processing advances from phase 230 to phase 240.

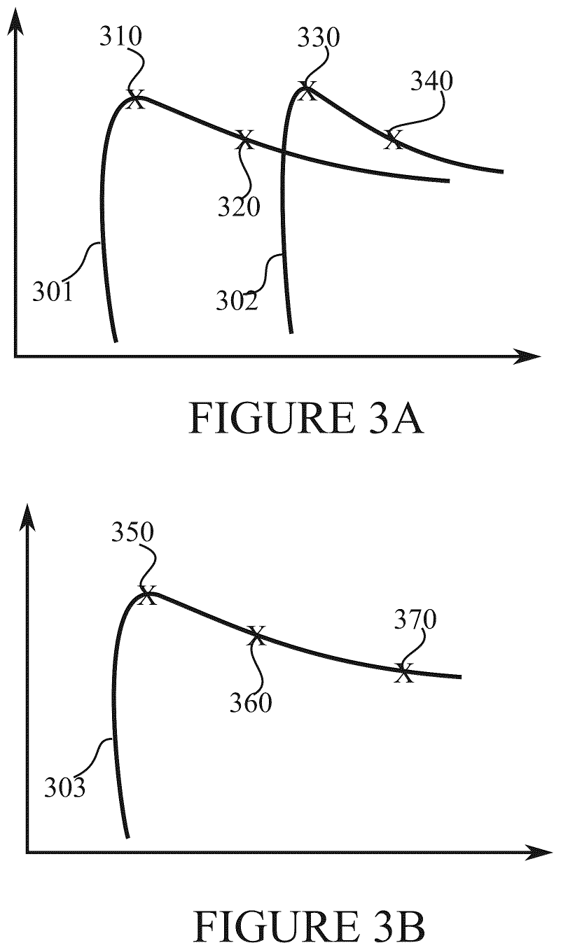

In phase 240, the first and second wireless input signals are updated for a new time interval. This may comprise updating a radio channel, Doppler shift and power level as described herein above. Processing advances to phase 250, where the MCS is updated for each of the input signals, if MCS update conditions are fulfilled. For example, the MCS may be changed at a constant simulated distance from a RRH, or based on channel quality indications received in the test equipment from the UE. MCS updating will be described in more detail in connection with FIGS. 3A and 3B. In phase 260, where processing advances to from phase 250, the test signals are received in the UE under test, and the UE sends feedback to the test equipment or records its performance in a log stored in the UE. In some embodiments, phase 250 is comprised in phase 240. Phases 240, 250 and 260 are comprised in data transmission from plural RRHs to the UE under test.

From phase 260, processing advances to phase 270, where, if appropriate a transmission from a next RRH is performed, unless this was performed simultaneously with the previous one in phases 240-260. After both RRHs have transmitted, processing advances from phase 270 to phase 280, where it is assessed if the test run has ended. If it has ended, processing advances to phase 290, where it is assessed, if the test run is successful. If it is successful, processing advances to phase 2110 where the test ends.

If, on the other hand, it is determined in phase 280 that the test run has not ended, processing advances from phase 280 back to phase 250, where more test data is transmitted to the UE under test over the two test signals. If it is determined in phase 290, that the test run has not succeeded, processing may return to phase 220 and the test may be re-run. For example, transmit power may be increased for this new run, resulting in SNR profiles which are higher than in the previous test, in a bid to reach the minimum throughput to pass the test.

FIG. 3A illustrates MCS switching in a test run. The illustrated process is a link adaptation procedure based on the SNR profiles, in the form of RSRP levels as a function of distance, or time, with two MCS switching points. Power increases from the bottom toward the top on the vertical axis, while the horizontal axis is a translational axis, advancing along track 101 of FIG. 1A. As the train moves along the rail track e.g. from left to right, the progress being along the horizontal axis, the SNR levels at antenna panel 1 and antenna panel 2 will change according to the relative distances of these receivers to their respective transmitting RRHs. The RSRP is denoted along the vertical axis. During the test run, the MCS for each link is adapted as appropriate for the changing RSRP. In the two-MCS test of FIG. 3, at distances corresponding to switch points 310 and 320 the SNR levels at a first antenna panel change from A₁ to A₂ (with A₁>A₂). In this case, with link adaptation, MCS1, corresponding to a more complex modulation, is selected for a first test beam 301 from a first simulated RRH in switch point 310, and MCS2, with a more robust approach and a less complex modulation, is switched to for the first test beam in point 320. As the train moves further, the SNR level will decline further. In this case, not only MCS2 is used but there is also a beam/TCI state switch or handover mechanism to serve this antenna panel. A switching offset, Ds_offset, may be used to trigger the switch process in case the switching is not, in the test, based on UE measurements. After the switch this antenna panel is served by a new simulated RRH test beam 302 from a second simulated RRH, with two MCS switching points as in the first simulated RRH period. Initially, as the signal of test beam 302 is strong, at point 330 MCS1 is selected for this test beam, until its strength has declined to a point where changing from MCS1 to MCS2 is appropriate, in point 340. For clarity, only beams serving a back-facing antenna panel are illustrated in FIG. 3A, however in a test there may be beams serving also a front-facing antenna panel, as described herein above.

The concept of FIG. 3A can be extended to more than two MCS levels. FIG. 3B illustrates MCS switching in a test run in a case where three MCS levels are used. For the sake of clarity, only a single simulated RRH beam is present in FIG. 3B, however, in an actual test, simulated switching from simulated RRH to simulated RRH can be performed in a three-MCS level case as well.

In FIG. 3B, initially a new test beam 303 from a RRH is attached to by an antenna panel of the UE under test, and at point 350 the most complex MCS is selected since signal strength is good. Following this, the signal strength begins to decline, until at point 360 it has declined to a point that the most complex, and thus highest-throughput, MCS is no longer appropriate and an intermediate MCS is chosen instead. The intermediate MCS is used until the signal strength has declined to an extent, that at point 370 MCS is changed once more, the most redundant, and thus most secure against fading, and least performative in terms of throughput, MCS is used instead after point 370.

Differently to earlier demodulation tests which only consider one MCS and its required SNR to reach performance criteria, in the herein disclosed test there are at least two MCS and their required SNRs to reach a defined performance criterion. The performance criterion may comprise, for example, 70% of total throughput from antenna panels 1 and 2. Furthermore, to assure that the performance of multi-RX can be achieved during the movement of e.g. a train in real deployments, 2-3 MCS pairs may be defined, corresponding to 2-3 pairs of required SNRs for achieving target performance based on the power profile. As in a performance testing procedure the UE will not necessarily continuously report the channel quality indicator, CQI, a method for mimicking the link adaptation may be used instead. For such a purpose, the following method may be used:

Firstly, a possible range of SNR during the movement of the U/E may be defined according to a power profile, which is given by:

$${R}_{SNR} ( dB ) = Max SNR - Min SNR$$

An SNR is defined step to change from one MCS to the next closest MCS, as given by, for example,

$${S}_{SNR} ( dB ) = max\_j ( SNR ( MCS ( j + 1 ) ) - SNR ( MCS ( j ) ) ) ,$$

$$j = 1 , … , ( m - 1 ) ,$$

with SNR(MCS(j)) the required SNR for MCS(j), j the MCS index and m the highest possible MCS index according to the chosen MCS table.

The possible number of MCS steps for the given R_{SNR}, is defined, as given by

$$N = {R}_{SNR} / {S}_{SNR}$$

The first corresponding MCSs pair at selected distance d₁, is defined (MCS(A₁), MCS(B₁)), after which the testing may be performed based on the given performance criterion. Another MCS pair may be defined at selected distance d₂ (MCS(A₂), MCS(B₂)) based on the power profile on the considered distance d₂ and the given step N. The performing of the test may be repeated. In case more performance testing is required, the steps of defining MCS pairs defining new MCS pairs and running the test may be repeated.

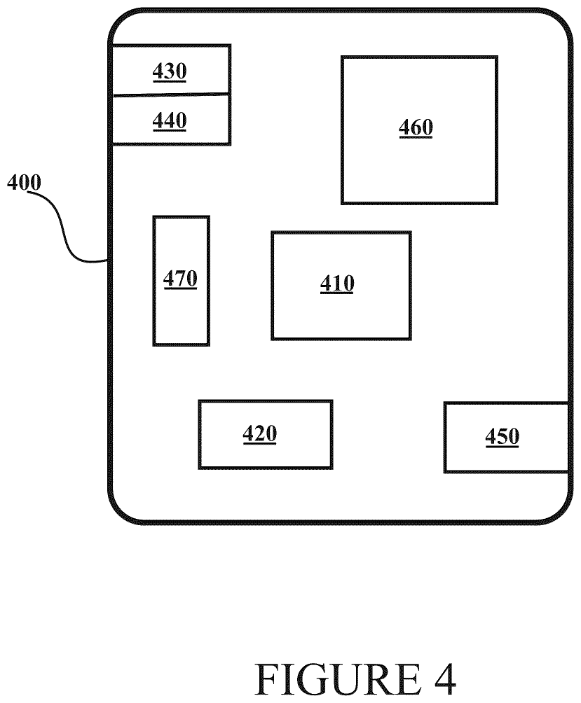

FIG. 4 illustrates an example apparatus capable of supporting at least some embodiments of the present invention. Illustrated is device 400, which may comprise, for example, a mobile communication device such UE or, in applicable parts, a set of test equipment. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. When processor 410 comprises more than one processor, device 400 may be a distributed device wherein processing of tasks takes place in more than one physical unit. Processor 410 may be a control device. A processing core may comprise, for example, a Cortex-A8 processing core manufactured by ARM Holdings or a Zen processing core designed by Advanced Micro Devices Corporation. A processing core or processor may be, or may comprise, at least one qubit. Processor 410 may comprise at least one Qualcomm Snapdragon and/or Intel Atom processor. Processor 410 may comprise at least one application-specific integrated circuit, ASIC. Processor 410 may comprise at least one field-programmable gate array, FPGA. Processor 410, optionally together with memory and computer instructions, may be means for performing method steps in device 400, such as determining, identifying, receiving, transmitting, beginning, updating and providing. Processor 410 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as UE or base station, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may be a computer readable medium. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part external to device 400 but accessible to device 400. Memory 420 may be transitory or non-transitory. The term “non-transitory”, as used herein, is a limitation of the medium itself (that is, tangible, not a signal) as opposed to a limitation on data storage persistency (for example, RAM vs. ROM).

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver. Transmitter 430 and/or receiver 440 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 400 may comprise a near-field communication, NFC, transceiver 450. NFC transceiver 450 may support at least one NFC technology, such as NFC, Bluetooth, Wibree or similar technologies.

Device 400 may comprise user interface, UI, 460. UI 460 may comprise at least one of a display, a keyboard, a touchscreen, a vibrator arranged to signal to a user by causing device 400 to vibrate, a speaker or a microphone. A user may be able to operate device 400 via UI 460, for example to accept incoming telephone calls, to originate telephone calls or video calls, to browse the Internet, to manage digital files stored in memory 420 or on a cloud accessible via transmitter 430 and receiver 440, or via NFC transceiver 450, and/or to play games.

Device 400 may comprise or be arranged to accept a user identity module 470. User identity module 470 may comprise, for example, a subscriber identity module, SIM, card installable in device 400. A user identity module 470 may comprise information identifying a subscription of a user of device 400. A user identity module 470 may comprise cryptographic information usable to verify the identity of a user of device 400 and/or to facilitate encryption of communicated information and billing of the user of device 400 for communication effected via device 400.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. For example, where device 400 comprises a smartphone, it may comprise at least one digital camera. Some devices 400 may comprise a back-facing camera and a front-facing camera, wherein the back-facing camera may be intended for digital photography and the front-facing camera for video telephony. Device 400 may comprise a fingerprint sensor arranged to authenticate, at least in part, a user of device 400. In some embodiments, device 400 lacks at least one device described above. For example, some devices 400 may lack a NFC transceiver 450 and/or user identity module 470.

Processor 410, memory 420, transmitter 430, receiver 440, NFC transceiver 450, UI 460 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the present invention.

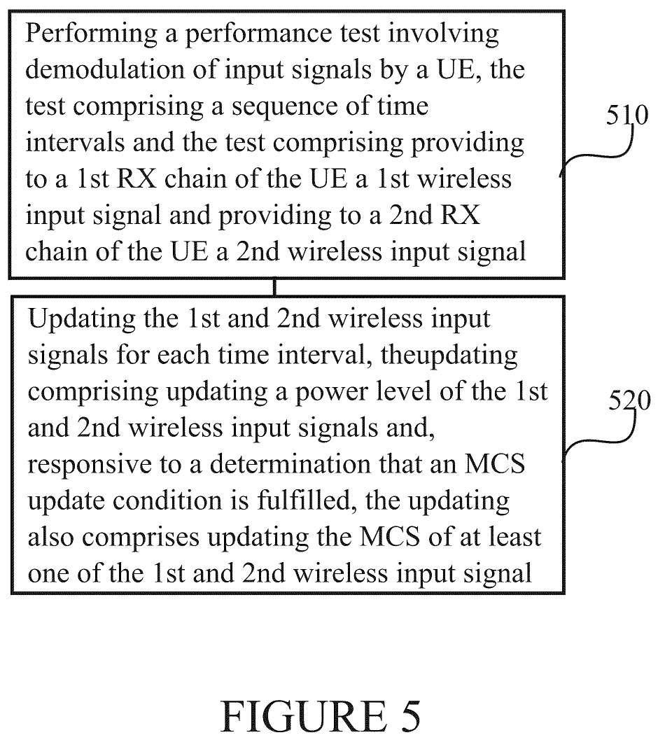

FIG. 5 is a flow graph of a method in accordance with at least some embodiments of the present invention. The phases of the illustrated method may be performed in a test equipment, for example, or in a control device configured to control the functioning thereof, when installed therein.

Phase 510 comprises performing a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal. Phase 520 comprises updating the first and second wireless input signals for each time interval, the updating comprising updating a power level of the first and second wireless input signals and, responsive to a determination that a modulation and coding scheme, MCS, update condition is fulfilled, the updating also comprises also updating the MCS of at least one of the first or the second wireless input signal. The MCS update condition may comprise, for example, that SNR has crossed a SNR threshold level, and/or that a bit error rate or block error rate has crossed an error threshold level.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

### INDUSTRIAL APPLICABILITY

At least some embodiments of the present invention find industrial application in cellular communications.

### ACRONYMS LIST

3GPP 3^{rd} generation partnership project
MCS modulation and coding scheme
RRH remote radio head
RSRP reference signal received power
RX receive/receiver
SNR signal to noise ratio
TX transmit/transmitter
UE user equipment

REFERENCE SIGNS LIST

| | |
|---|---|
| 101 | track |
| 110 | UE |
| 120, 130 | RRHs |
| 121, 122, 131, 132 | beams |
| 210-2110 | phases of the process of FIG. 2 |
| 301, 302, 303 | test beams |
| 310, 320, 330, 340, | MCS switch points |
| 350, 360, 370 | |
| 400-470 | structure of the device of FIG. 4 |
| 510-520 | phases of the method of FIG. 5 |

1.-18. (canceled)

19. An apparatus comprising at least one processing core and at least one memory storing instructions that, when executed by the at least one processing core, cause the apparatus at least to:
perform a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and
update the first and second wireless input signals for each time interval, the updating comprising updating a power level of the first and second wireless input signals and, responsive to a determination that a modulation and coding scheme, MCS, update condition is fulfilled, the updating also comprises updating the MCS of at least one of the first or the second wireless input signal.

20. The apparatus according to claim 19, wherein the MCS update condition comprises at least one of the following: a simulated reference signal received power level crosses a threshold level, or a simulated position of the user equipment in the test passes a threshold distance from a simulated fixed transmitter.

21. The apparatus according to claim 19, further configured to update, for each time interval, a fading profile of the first and second wireless input signals.

22. The apparatus according to claim 19, further configured to update, for each time interval, a transmission frequency of the first and second wireless input signals.

23. The apparatus according to claim 19, further configured to provide the first wireless input signal at a higher power than the second wireless input signal.

24. The apparatus according to claim 19, further configured to include in the test of demodulation performance at least one simulated change of attachment of the user equipment from a first transmission reception point, TRP, to a second TRP.

25. The apparatus according to claim 19, further configured to determine whether the user equipment passes the test of demodulation performance based on comparing at least two achieved throughputs to at least two threshold throughputs, wherein each threshold throughput is specific to a MCS.

26. The apparatus according to claim 19, wherein, for at least one of the time intervals, the apparatus is configured to provide the first wireless input signal with a different MCS than the second wireless input signal.

27. A method comprising:
performing a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and
updating the first and second wireless input signals for each time interval, the updating comprising updating a power level of the first and second wireless input signals and, responsive to a determination that a modulation and coding scheme, MCS, update condition is fulfilled, the updating also comprises also updating the MCS of at least one of the first or the second wireless input signal.

28. The method according to claim 27, wherein the MCS update condition comprises at least one of the following: a simulated reference signal received power level crosses a threshold level, or a simulated position of the user equipment in the test passes a threshold distance from a simulated fixed transmitter.

29. The method according to claim 27, further comprising updating, for each time interval, a fading profile of the first and second wireless input signals.

30. The method according to claim 27, further comprising updating, for each time interval, a frequency of the first and second wireless input signals.

31. The method according to claim 27, further comprising including in the test of demodulation performance at least one simulated change of attachment of the user equipment from a first transmission reception point, TRP, to a second TRP.

32. The method according to claim 27, further comprising determining whether the user equipment passes the test of demodulation performance based on comparing at least two achieved throughputs to at least two threshold throughputs, wherein each threshold throughput is specific to a MCS.

33. The method according to claim 27, wherein, for at least one of the time intervals, the method comprises providing the first wireless input signal with a different MCS than the second wireless input signal.

34. An apparatus comprising means for:
performing a performance test involving demodulation of input signals by a user equipment, the test comprising a sequence of consecutive time intervals and the test comprising providing to a first receive chain of the user equipment a first wireless input signal and providing to a second receive chain of the user equipment a second wireless input signal, and
updating the first and second wireless input signals for each time interval, the updating comprising updating a power level of the first and second wireless input signals and, responsive to a determination that a modulation and coding scheme, MCS, update condition is fulfilled, the updating also comprises also updating the MCS of at least one of the first or the second wireless input signal.

35. The apparatus according to claim 34, wherein, for at least one of the time intervals, the apparatus is configured to provide the first wireless input signal with a different MCS than the second wireless input signal.
